(19) United States
(12) Patent Application Publication
(10) Pub. No.: US 2025/0309667 A1
(43) Pub. Date: Oct. 2, 2025

(54) ELECTRIC POWER SUPPLY SYSTEM

(71) Applicant: TATSUMI RYOKI CO., LTD, Tokyo (JP)

(72) Inventor: Toyoshi KONDO, Tokyo (JP)

(21) Appl. No.: 18/865,242

(22) PCT Filed: May 26, 2022
(86) PCT No.: PCT/JP2022/021523

§ 371 Date: Nov. 12, 2024

(51) Int. Cl. H02J 7/00; H02J 7/34; H02J 7/35

(52) U.S. Cl. CPC H02J 7/0063; H02J 7/0024; H02J 7/0047; H02J 7/00712; H02J 7/345; H02J 7/35; H02J 2207/50

(57) ABSTRACT

An electric power supply system supplies electric power to an external load, and includes an electric power generation unit that generates electric power, an electric power storage unit including a plurality of electric power storage devices, and a switching unit that switches connection states of the plurality of electric power storage devices. The electric power obtained by the electric power generation unit is supplied to the electric power storage unit in a state where the plurality of electric power storage devices are connected in series via the switching unit. The electric power stored in the electric power storage unit is supplied to a load in a state where at least a state where one of the plurality of electric power storage devices is used and a state where at least some of the plurality of electric power storage devices are connected in parallel are switchable via a switching unit.

### TECHNICAL FIELD

The present invention relates to an electric power supply system and the like.

### BACKGROUND ART

Hitherto, there has been proposed an electric vehicle charge/discharge device that stores electric power and supplies the stored electric power to an electric vehicle or the like as in Patent Literature 1.

### CITATION LIST

### Patent Literature

Patent Literature 1: JP 2015-208132 A

### SUMMARY OF INVENTION

### Technical Problem

However, charge/discharge control of a plurality of electric power storage devices is not considered.

In this regard, an object of the present invention is to provide an electric power supply system and the like capable of efficiently supplying electric power to a load by using a plurality of electric power sources.

### Solution to Problem

An electric power supply system according to the present invention is an electric power supply system that supplies electric power to an external load, the electric power supply system including an electric power generation unit configured to generate electric power, an electric power storage unit including a plurality of electric power storage devices, and a switching unit configured to switch connection states of the plurality of electric power storage devices.

The electric power obtained by the electric power generation unit is supplied to the electric power storage unit in a state where the plurality of electric power storage devices are connected in series via the switching unit.

The electric power stored in the electric power storage unit is supplied to the load in a state where at least a state where one of the plurality of electric power storage devices is used and a state where at least some of the plurality of electric power storage devices are connected in parallel are switchable via the switching unit.

The plurality of electric power storage devices are connected in series in a charge mode.

As a result, a current flowing from the electric power generation unit to an electric power line connecting the electric power storage units can be reduced, and a smaller-diameter cable can be used as said electric power line as compared with a form in which the plurality of electric power storage devices are connected in parallel in the charge mode.

All of the plurality of electric power storage devices are connected in parallel in a discharge mode, or one of the plurality of electric power storage devices is used in the discharge mode.

As a result, it is possible to supply lower-voltage electric power to the load as compared with a form in which the plurality of electric power storage devices are connected in series in the discharge mode.

In the present embodiment, some of the plurality of electric power storage devices are connected in series and some of the plurality of electric power storage devices are connected in parallel in the discharge mode.

As a result, it is possible to supply higher-voltage electric power to the load as compared with a form in which all of the plurality of electric power storage devices are connected in parallel in the discharge mode.

That is, it is possible to provide an electric power supply system and the like capable of efficiently supplying electric power to a load by using a plurality of electric power sources.

Preferably, the plurality of electric power storage devices include a first electric power storage device and a second electric power storage device.

The electric power storage unit includes a first charge control device connected in parallel to the first electric power storage device, and a second charge control device connected in parallel to the second electric power storage device.

The first charge control device detects a first charge rate of the first electric power storage device.

The second charge control device detects a second charge rate of the second electric power storage device. The first charge control device suppresses electric power supply from the electric power generation unit to the first electric power storage device in a case where the first charge rate is equal to or higher than a first charge rate threshold.

The second charge control device suppresses electric power supply from the electric power generation unit to the second electric power storage device in a case where the second charge rate is equal to or higher than the first charge rate threshold.

The electric power from the electric power generation unit is supplied to the electric power storage device having a low charge rate, and is not supplied to the electric power storage device having a high charge rate. Therefore, it is possible to charge the electric power storage device having a low charge rate at an early stage while preventing deterioration of the electric power storage device having a high charge rate.

More preferably, the electric power supply system further includes a detection unit configured to detect information regarding the electric power supplied from the electric power generation unit to the electric power storage unit.

The first charge control device suppresses electric power supply from the electric power generation unit to the first electric power storage device based on the information obtained by the detection unit in a case where the first charge rate is lower than the first charge rate threshold and is equal to or higher than a second charge rate threshold lower than the first charge rate threshold.

The second charge control device suppresses electric power supply from the electric power generation unit to the second electric power storage device based on the information obtained by the detection unit in a case where the second charge rate is lower than the first charge rate threshold and equal to or higher than the second charge rate threshold.

The electric power from the electric power generation unit is supplied to the electric power storage device having a low charge rate, and is not supplied to the electric power storage device having a high charge rate. The presence or absence of electric power supply from the electric power generation unit to the electric power storage device having a medium charge rate is controlled based on the information regarding electric power supplied from the electric power generation unit to the electric power storage unit. Therefore, it is possible to charge the electric power storage device having a low charge rate at an early stage according to an electric power supply situation.

Preferably, the electric power supply system further includes an operation unit.

The plurality of electric power storage devices include a third electric power storage device.

The electric power storage unit includes a third charge control device connected in parallel to the third electric power storage device.

The third charge control device detects a third charge rate of the third electric power storage device.

The third charge control device suppresses electric power supply from the electric power generation unit to the third electric power storage device in a case where the third charge rate is equal to or higher than the first charge rate threshold.

The electric power from the electric power generation unit is supplied to one or more of the first to third electric power storage devices whose charge rate is lower than the first charge rate threshold, for a load test of the electric power generation unit according to a load amount set via the operation unit, and electric power supply from the electric power generation unit to other electric power storage devices is suppressed by any of the first to third charge control devices.

The load test of the electric power generation unit can also be performed by selecting the number of electric power storage device to be charged by a manual operation using the operation unit.

Preferably, the switching unit includes a plurality of switches.

A normally closed contact and a fixed contact of each of the plurality of switches are connected when the electric power obtained by the electric power generation unit is supplied to the electric power storage unit.

A normally open contact and the fixed contact of at least one of the plurality of switches are connected when the electric power stored in the electric power storage unit is supplied to the load.

A movable contact of each switch of the switching unit that is connected to the fixed contact in the charge mode is set to the normally closed contact.

Therefore, in a case where charge rates of the plurality of electric power storage devices of the electric power storage unit are low and each of the movable contacts cannot be driven, the charge mode is maintained, and the electric power obtained by the electric power generation unit is supplied to the electric power storage unit.

More preferably, the electric power supply system further includes a detection unit configured to detect at least one of information regarding the electric power supplied from the electric power storage unit to the load or information regarding charge states of the plurality of electric power storage devices, and a control unit configured to control the switching unit when supplying the electric power from the electric power storage unit to the load based on the information obtained by the detection unit.

It is possible to optimize the connection states of the plurality of electric power storage devices when the electric power is supplied from the electric power storage unit to the load based on at least one of the information regarding the electric power supplied from the electric power storage unit to the load and the information regarding the charge states of the plurality of electric power storage devices.

Preferably, the electric power supply system receives electric power supply from an external test target power source.

The electric power storage unit is used for a load test of the test target power source.

Electric power supply from the test target power source to the electric power storage unit is performed in a state where a state where one of the plurality of electric power storage devices is used, a state where at least some of the plurality of electric power storage devices are connected in parallel, and a state where the plurality of electric power storage devices are connected in series are switchable via the switching unit.

The load test of the test target power source can be performed while switching the connection states of the plurality of electric power storage devices by using the plurality of electric power storage devices, and the electric power storage device can be charged.

More preferably, the electric power supply system further includes a bidirectional AC/DC converter.

In a case where the load is driven by AC power and receives the electric power supplied from the electric power storage unit, the bidirectional AC/DC converter converts a flow of electricity of the electric power from the electric power storage unit from DC to AC.

In a case where the test target power source is a device that generates AC power and supplies the electric power to the electric power storage unit, the bidirectional AC/DC converter converts a flow of electricity of the electric power from the test target power source from AC to DC.

The load driven by AC power and the test target power source that generates AC power can be exchanged and used without changing an internal structure of the electric power supply system.

Preferably, at least two of the plurality of electric power storage devices are stacked via an insulator.

It is possible to dispose a large number of electric power storage devices in a predetermined region while maintaining insulation properties.

More preferably, the plurality of electric power storage devices are removably held.

Preferably, the electric power generation unit includes a plurality of solar panels.

The plurality of solar panels are connected in series.

### Advantageous Effects of Invention

As described above, according to the present invention, it is possible to provide an electric power supply system and the like capable of efficiently supplying electric power to a load by using a plurality of electric power sources.

### BRIEF DESCRIPTION OF DRAWINGS

FIG. 1 is a main configuration diagram of an electric power supply system according to the present embodiment.

FIG. 2 is a detailed configuration diagram of the electric power supply system in a charge mode.

FIG. 3 is a detailed configuration diagram of the electric power supply system in a first discharge mode.

FIG. 4 is a detailed configuration diagram of the electric power supply system in a second discharge mode.

FIG. 5 is a detailed configuration diagram of the electric power supply system in a third discharge mode.

FIG. 6 is a detailed configuration diagram of the electric power supply system in a fourth discharge mode.

FIG. 7 is a detailed configuration diagram of the electric power supply system in a load test mode for a direct current (DC) test target power source.

FIG. 8 is a detailed configuration diagram of the electric power supply system in a load test mode for an alternating current (AC) test target power source.

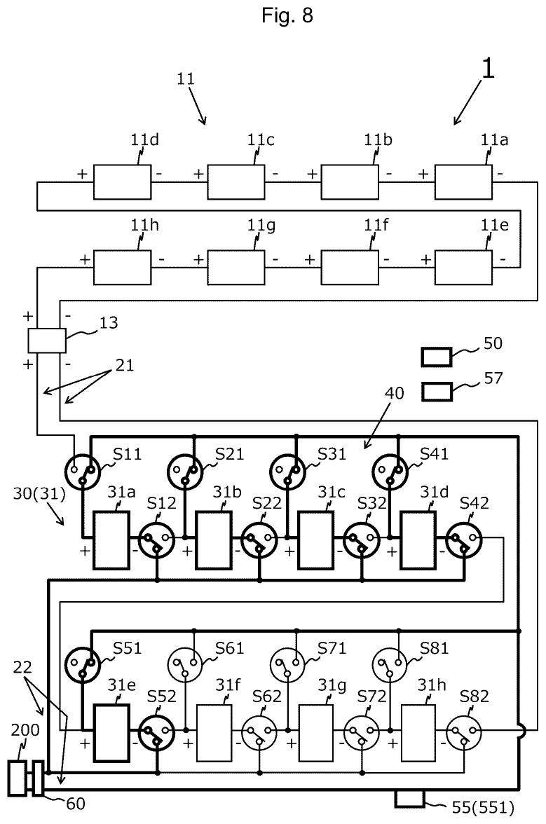

FIG. 9 is a detailed configuration diagram of the electric power supply system including a first charge control device and the like.

### DESCRIPTION OF EMBODIMENTS

Hereinafter, the present embodiment will be described with reference to the drawings.

Note that the embodiment is not limited to the following embodiment. In addition, the contents described in one embodiment are similarly applied to other embodiments in principle. Further, each embodiment and each modification can be appropriately combined.

### (Electric Power Supply System 1)

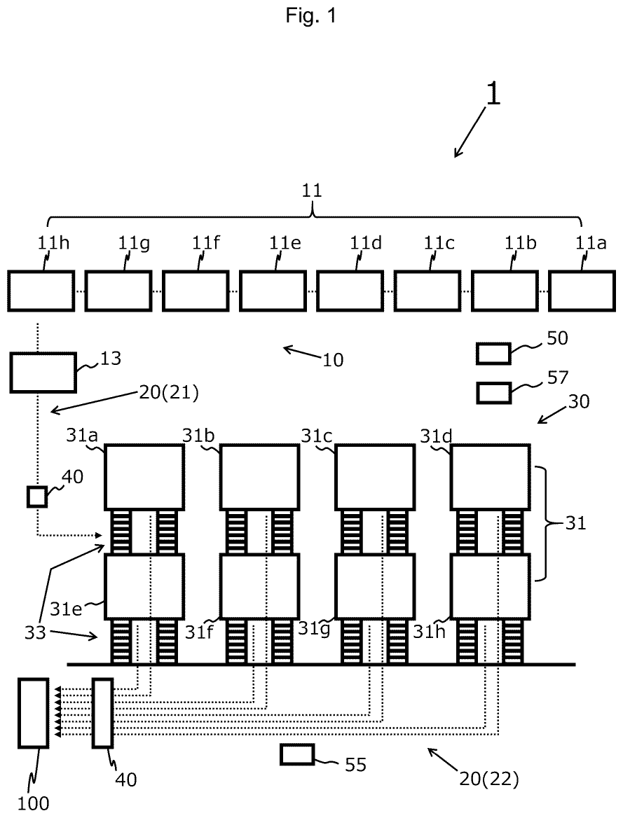

An electric power supply system 1 of the present embodiment includes an electric power generation unit 10, an electric power supply unit 20, an electric power storage unit 30, a switching unit 40, and an operation unit 50 (see FIGS. 1 to 3).

### (Electric Power Generation Unit 10)

The electric power generation unit 10 generates electric power like a generator.

In the present embodiment, the electric power generation unit 10 includes an electric power generation device 11 and a charge/discharge controller 13.

The electric power generation device 11 includes a plurality of solar panels (first to eighth solar panels 11a to 11h).

The charge/discharge controller 13 controls charge and discharge of the electric power generation device 11.

### (Electric Power Supply Unit 20)

The electric power supply unit 20 includes a first electric power line 21 and a second electric power line 22. The first electric power line 21 is used as an electric power supply line from the electric power generation unit 10 to the electric power storage unit 30.

The first electric power line 21 connects the plurality of solar panels of the electric power generation unit 10 in series.

The second electric power line 22 is used as an electric power supply line from the electric power storage unit 30 to a load 100.

Specific wirings of the first electric power line 21 and the second electric power line 22 are described below.

### (Electric Power Storage Unit 30)

The electric power storage unit 30 stores the electric power generated by the electric power generation unit 10.

The electric power storage unit 30 includes a plurality of electric power storage devices 31 (first to eighth electric power storage devices 31a to 31h) and insulators 33. Each of the plurality of electric power storage devices 31 includes a battery, a capacitor, and the like. Each of the plurality of electric power storage devices 31 may be fixedly installed on a base portion that holds the electric power storage device 31 or may be installed so as to be removable from said base portion.

The plurality of electric power storage devices 31 are stacked in a vertical direction.

In the present embodiment, the fifth electric power storage device 31e is installed on a ground via the insulator 33, and the first electric power storage device 31a is installed on the fifth electric power storage device 31e via the insulator 33.

The sixth electric power storage device 31f is installed on the ground via the insulator 33, and the second electric power storage device 31b is installed on the sixth electric power storage device 31f via the insulator 33.

The seventh electric power storage device 31g is installed on the ground via the insulator 33, and the third electric power storage device 31c is installed on the seventh electric power storage device 31g via the insulator 33.

The eighth electric power storage device 31h is installed on the ground via the insulator 33, and the fourth electric power storage device 31d is installed on the eighth electric power storage device 31h via the insulator 33.

However, the number of stacked electric power storage devices in the vertical direction is not limited to two.

### (Switching Unit 40)

The switching unit 40 switches connection states of the plurality of electric power storage devices 31.

The switching unit 40 includes a plurality of double throw switches (an 11-th switch S11, a 12-th switch S12, a 21-th switch S21, a 22-th switch S22, a 31-th switch S31, a 32-th switch S32, a 41-th switch S41, a 42-th switch S42, a 51-th switch S51, a 52-th switch S52, a 61-th switch S61, a 62-th switch S62, a 71-th switch S71, a 72-th switch S72, an 81-th switch S81, and an 82-th switch S82).

However, the 21-th switch S21, the 31-th switch S31, the 41-th switch S41, the 51-th switch S51, the 61-th switch S61, the 71-th switch S71, and the 81-th switch S81 may be single throw switches.

A movable contact of the switch of the switching unit 40 is driven by the electric power of the electric power storage unit 30.

### (11-th Switch S11)

One (normally closed contact) of the movable contacts of the 11-th switch S11 is connected to a positive terminal of the charge/discharge controller 13.

The other (normally open contact) of the movable contacts of the 11-th switch S11 is connected to a positive terminal of the load 100 and the like.

A fixed contact of the 11-th switch S11 is connected to a positive terminal of the first electric power storage device 31a.

### (12-th Switch S12)

One (normally closed contact) of the movable contacts of the 12-th switch S12 is connected to a positive terminal of the second electric power storage device 31b and the like.

The other (normally open contact) of the movable contacts of the 12-th switch S12 is connected to a negative terminal of the load 100 and the like.

A fixed contact of the 12-th switch S12 is connected to a negative terminal of the first electric power storage device 31a.

The 11-th switch S11 and the 12-th switch S12 sandwich the first electric power storage device 31a.

### (21-th Switch S21)

One (normally closed contact) of the movable contacts of the 21-th switch S21 is not connected to another device.

The other (normally open contact) of the movable contacts of the 21-th switch S21 is connected to the positive terminal of the load 100 and the like.

A fixed contact of the 21-th switch S21 is connected to the positive terminal of the second electric power storage device 31b and the like.

### (22-th Switch S22)

One (normally closed contact) of the movable contacts of the 22-th switch S22 is connected to a positive terminal of the third electric power storage device 31c and the like.

The other (normally open contact) of the movable contacts of the 22-th switch S22 is connected to the negative terminal of the load 100 and the like.

A fixed contact of the 22-th switch S22 is connected to a negative terminal of the second electric power storage device 31b.

The 21-th switch S21 and the 22-th switch S22 sandwich the second electric power storage device 31b.

### (31-th Switch S31)

One (normally closed contact) of the movable contacts of the 31-th switch S31 is not connected to another device.

The other (normally open contact) of the movable contacts of the 31-th switch S31 is connected to the positive terminal of the load 100 and the like.

A fixed contact of the 31-th switch S31 is connected to the positive terminal of the third electric power storage device 31c and the like.

### (32-th Switch S32)

One (normally closed contact) of the movable contacts of the 32-th switch S32 is connected to a positive terminal of the fourth electric power storage device 31d and the like.

The other (normally open contact) of the movable contacts of the 32-th switch S32 is connected to the negative terminal of the load 100 and the like.

A fixed contact of the 32-th switch S32 is connected to a negative terminal of the third electric power storage device 31c.

The 31-th switch S31 and the 32-th switch S32 sandwich the third electric power storage device 31c.

### (41-th Switch S41)

One (normally closed contact) of the movable contacts of the 41-th switch S41 is not connected to another device.

The other (normally open contact) of the movable contacts of the 41-th switch S41 is connected to the positive terminal of the load 100 and the like.

A fixed contact of the 41-th switch S41 is connected to the positive terminal of the fourth electric power storage device 31d and the like.

### (42-th Switch S42)

One (normally closed contact) of the movable contacts of the 42-th switch S42 is connected to a positive terminal of the fifth electric power storage device 31e and the like.

The other (normally open contact) of the movable contacts of the 42-th switch S42 is connected to the negative terminal of the load 100 and the like.

A fixed contact of the 42-th switch S42 is connected to a negative terminal of the fourth electric power storage device 31d.

The 41-th switch S41 and the 42-th switch S42 sandwich the fourth electric power storage device 31d.

### (51-th Switch S51)

One (normally closed contact) of the movable contacts of the 51-th switch S51 is not connected to another device. The other (normally open contact) of the movable contacts of the 51-th switch S51 is connected to the positive terminal of the load 100 and the like.

A fixed contact of the 51-th switch S51 is connected to the positive terminal of the fifth electric power storage device 31e and the like.

### (52-th Switch S52)

One (normally closed contact) of the movable contacts of the 52-th switch S52 is connected to a positive terminal of the sixth electric power storage device 31f and the like.

The other (normally open contact) of the movable contacts of the 52-th switch S52 is connected to the negative terminal of the load 100 and the like.

A fixed contact of the 52-th switch S52 is connected to a negative terminal of the fifth electric power storage device 31e.

The 51-th switch S51 and the 52-th switch S52 sandwich the fifth electric power storage device 31e.

### (61-th Switch S61)

One (normally closed contact) of the movable contacts of the 61-th switch S61 is not connected to another device.

The other (normally open contact) of the movable contacts of the 61-th switch S61 is connected to the positive terminal of the load 100 and the like.

A fixed contact of the 61-th switch S61 is connected to the positive terminal of the sixth electric power storage device 31f and the like.

### (62-th Switch S62)

One (normally closed contact) of the movable contacts of the 62-th switch S62 is connected to a positive terminal of the seventh electric power storage device 31g and the like.

The other (normally open contact) of the movable contacts of the 62-th switch S62 is connected to the negative terminal of the load 100 and the like.

A fixed contact of the 62-th switch S62 is connected to a negative terminal of the sixth electric power storage device 31f.

The 61-th switch S61 and the 62-th switch S62 sandwich the sixth electric power storage device 31f.

### (71-th Switch S71)

One (normally closed contact) of the movable contacts of the 71-th switch S71 is not connected to another device.

The other (normally open contact) of the movable contacts of the 71-th switch S71 is connected to the positive terminal of the load 100 and the like.

A fixed contact of the 71-th switch S71 is connected to the positive terminal of the seventh electric power storage device 31g and the like.

### (72-th Switch S72)

One (normally closed contact) of the movable contacts of the 72-th switch S72 is connected to a positive terminal of the eighth electric power storage device 31h and the like.

The other (normally open contact) of the movable contacts of the 72-th switch S72 is connected to the negative terminal of the load 100 and the like.

A fixed contact of the 72-th switch S72 is connected to a negative terminal of the seventh electric power storage device 31g.

The 71-th switch S71 and the 72-th switch S72 sandwich the seventh electric power storage device 31g.

### (81-th Switch S81)

One (normally closed contact) of the movable contacts of the 81-th switch S81 is not connected to another device.

The other (normally open contact) of the movable contacts of the 81-th switch S81 is connected to the positive terminal of the load 100 and the like.

A fixed contact of the 81-th switch S81 is connected to the positive terminal of the eighth electric power storage device 31h and the like.

### (82-th Switch S82)

One of the movable contacts (normally closed contact) of the 82-th switch S82 is connected to a negative terminal of the charge/discharge controller 13.

The other (normally open contact) of the movable contacts of the 82-th switch S82 is connected to the negative terminal of the load 100 and the like.

A fixed contact of the 82-th switch S82 is connected to a negative terminal of the eighth electric power storage device 31h.

The 81-th switch S81 and the 82-th switch S82 sandwich the eighth electric power storage device 31h.

### (Details of First Electric Power Line 21)

The first electric power line 21 connects a positive terminal of the first solar panel 11a and a negative terminal of the second solar panel 11b.

The first electric power line 21 connects a positive terminal of the second solar panel 11b and a negative terminal of the third solar panel 11c.

The first electric power line 21 connects a positive terminal of the third solar panel 11c and a negative terminal of the fourth solar panel 11d.

The first electric power line 21 connects a positive terminal of the fourth solar panel 11d and a negative terminal of the fifth solar panel 11e.

The first electric power line 21 connects a positive terminal of the fifth solar panel 11e and a negative terminal of the sixth solar panel 11f.

The first electric power line 21 connects a positive terminal of the sixth solar panel 11f and a negative terminal of the seventh solar panel 11g.

The first electric power line 21 connects a positive terminal of the seventh solar panel 11g and a negative terminal of the eighth solar panel 11h.

The first electric power line 21 connects a positive terminal of the eighth solar panel 11h and the positive terminal of the charge/discharge controller 13.

The first electric power line 21 connects the positive terminal of the charge/discharge controller 13 and one (normally closed contact) of the movable contacts of the 11-th switch S11.

The first electric power line 21 connects the negative terminal of the first solar panel 11a and the negative terminal of the charge/discharge controller 13.

The first electric power line 21 connects the negative terminal of the charge/discharge controller 13 and one (normally closed contact) of the movable contacts of the 82-th switch S82.

### (Details of Second Electric Power Line 22)

The second electric power line 22 connects the other (normally open contact) of the movable contacts of each of the 11-th switch S11, the 21-th switch S21, the 31-th switch S31, the 41-th switch S41, the 51-th switch S51, the 61-th switch S61, the 71-th switch S71, and the 81-th switch S81 to the positive terminal of the load 100.

The second electric power line 22 connects the other (normally open contact) of the movable contacts of each of the 12-th switch S12, the 22-th switch S22, the 32-th switch S32, the 42-th switch S42, the 52-th switch S52, the 62-th switch S62, the 72-th switch S72, and the 82-th switch S82 to the negative terminal of the load 100.

### (Operation of Switching Unit 40 in Charge Mode)

Supply of the electric power obtained by the electric power generation unit 10 to the electric power storage unit 30 is performed in a state where the plurality of electric power storage devices 31 are connected in series via the switching unit 40.

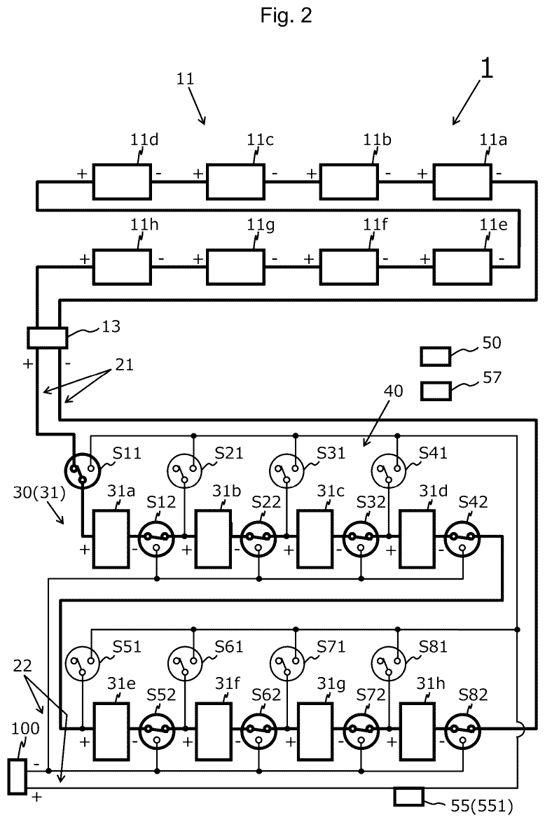

Specifically, the normally closed contact and the fixed contact of each switch of the switching unit 40 are connected (see FIG. 2).

FIG. 2 illustrates a state where the normally closed contacts and the fixed contacts of the 11-th switch S11, the 12-th switch S12, the 21-th switch S21, the 22-th switch S22, the 31-th switch S31, the 32-th switch S32, the 41-th switch S41, the 42-th switch S42, the 51-th switch S51, the 52-th switch S52, the 61-th switch S61, the 62-th switch S62, the 71-th switch S71, the 72-th switch S72, the 81-th switch S81, and the 82-th switch S82 are connected.

In this case, the electric power is supplied from the electric power generation unit 10 to the first to eighth electric power storage devices 31a to 31h in a state where the first to eighth electric power storage devices 31a to 31h are connected in series.

### (Operation of Switching Unit 40 in Discharge Mode)

Supply of the electric power stored in the electric power storage unit 30 to the load 100 is performed in a state where the plurality of electric power storage devices 31 are connected in parallel via the switching unit 40 (first discharge mode).

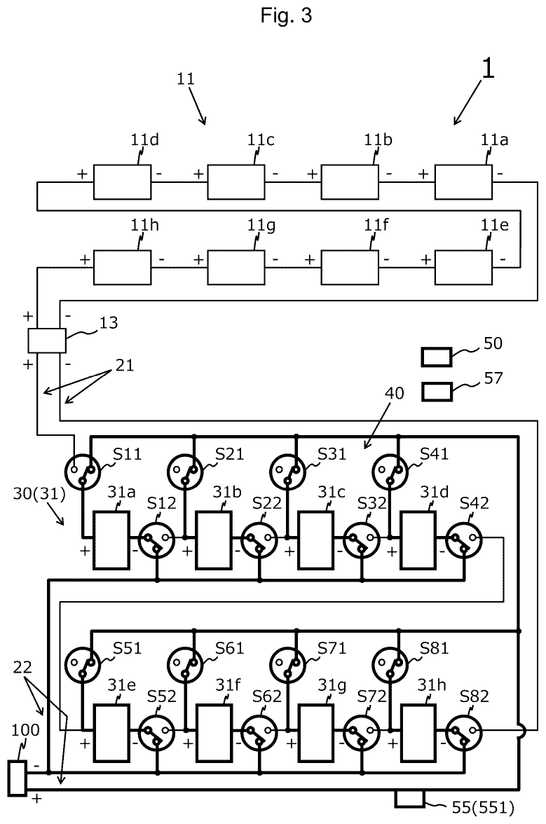

Specifically, the normally open contact and the fixed contact of each switch of the switching unit 40 are connected (see FIG. 3).

FIG. 3 illustrates a state where the normally open contacts and the fixed contacts of the 11-th switch S11, the 12-th switch S12, the 21-th switch S21, the 22-th switch S22, the 31-th switch S31, the 32-th switch S32, the 41-th switch S41, the 42-th switch S42, the 51-th switch S51, the 52-th switch S52, the 61-th switch S61, the 62-th switch S62, the 71-th switch S71, the 72-th switch S72, the 81-th switch S81, and the 82-th switch S82 are connected.

In this case, the electric power is supplied from the first to eighth electric power storage devices 31a to 31h to the load 100 in a state where the first to eighth electric power storage devices 31a to 31h are connected in parallel.

### (Application Example 1 of Operation of Switching Unit 40 in Discharge Mode)

Supply of the electric power stored in the electric power storage unit 30 to the load 100 may be performed in a state where some of the plurality of electric power storage devices 31 are connected in series and some of the plurality of electric power storage devices 31 are connected in parallel via the switching unit 40 (second discharge mode).

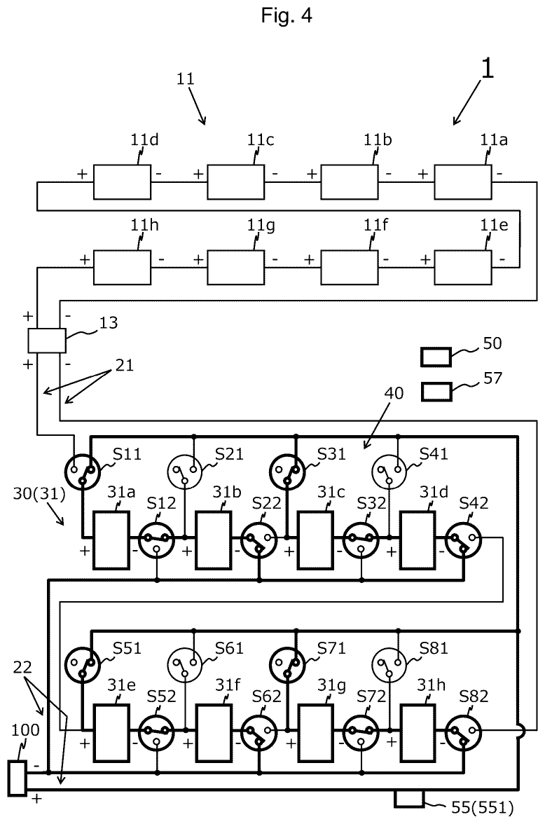

Specifically, the normally closed contacts and the fixed contacts of some switches of the switching unit 40 are connected, and the normally open contacts and the fixed contacts of the remaining switches of the switching unit 40 are connected (see FIG. 4).

FIG. 4 illustrates a state where the normally closed contacts and the fixed contacts of the 12-th switch S12, the 21-th switch S21, the 32-th switch S32, the 41-th switch S41, the 52-th switch S52, the 61-th switch S61, the 72-th switch S72, and the 81-th switch S81 are connected, and the normally open contacts and the fixed contacts of the 11-th switch S11, the 22-th switch S22, the 31-th switch S31, the 42-th switch S42, the 51-th switch S51, the 62-th switch S62, the 71-th switch S71, and the 82-th switch S82 are connected.

In this case, the first electric power storage device 31a and the second electric power storage device 31b are connected in series, the third electric power storage device 31c and the fourth electric power storage device 31d are connected in series, the fifth electric power storage device 31e and the sixth electric power storage device 31f are connected in series, and the seventh electric power storage device 31g and the eighth electric power storage device 31h are connected in series. Further, the electric power is supplied from the first to eighth electric power storage devices 31a to 31h to the load 100 in a state where a set of the first electric power storage device 31a and the second electric power storage device 31b, a set of the third electric power storage device 31c and the fourth electric power storage device 31d, a set of the fifth electric power storage device 31e and the sixth electric power storage device 31f, and a set of the seventh electric power storage device 31g and the eighth electric power storage device 31h are connected in parallel.

### (Application Example 2 of Operation of Switching Unit 40 in Discharge Mode)

The electric power stored in the electric power storage unit 30 may be supplied to the load 100 in a state where some of the plurality of electric power storage devices 31 are connected in parallel and some of the plurality of electric power storage devices 31 are not used (third discharge mode) via the switching unit 40.

The electric power stored in the electric power storage unit 30 may be supplied to the load 100 in a state where one of the plurality of electric power storage devices 31 is used and the remaining electric power storage devices are not used via the switching unit 40.

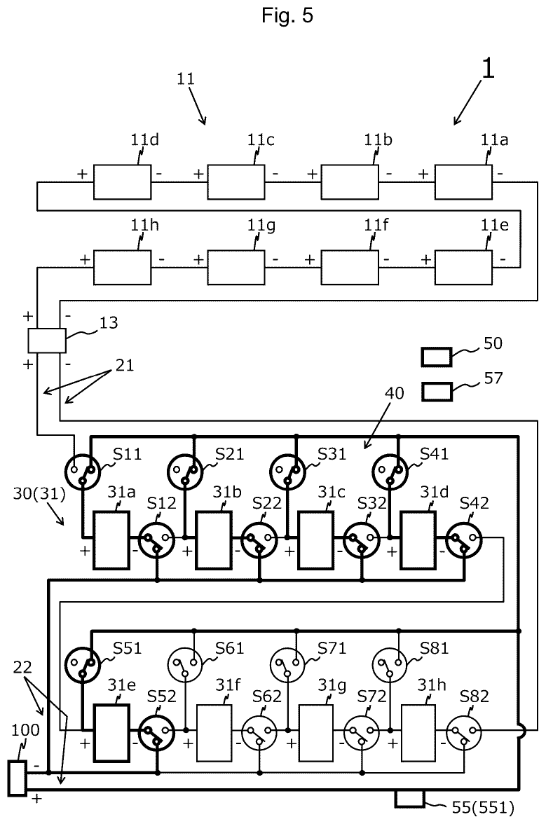

Specifically, the normally closed contacts and the fixed contacts of some switches of the switching unit 40 are connected, and the normally open contacts and the fixed contacts of the remaining switches of the switching unit 40 are connected (see FIG. 5).

FIG. 5 illustrates a state where the normally open contacts and the fixed contacts of the 11-th switch S11, the 12-th switch S12, the 21-th switch S21, the 22-th switch S22, the 31-th switch S31, the 32-th switch S32, the 41-th switch S41, the 42-th switch S42, the 51-th switch S51, the 52-th switch S52, the 62-th switch S62, the 72-th switch S72, and the 82-th switch S82 are connected, and the normally closed contacts and the fixed contacts of the 61-th switch S61, the 71-th switch S71, and the 81-th switch S81 are connected. The normally closed contacts and the fixed contacts of the 62-th switch S62, the 72-th switch S72, and the 82-th switch S82 may be connected. In this case, the electric power is supplied from the first to fifth electric power storage devices 31a to 31e to the load 100 in a state where the first to fifth electric power storage devices 31a to 31e are connected in parallel. The sixth to eighth electric power storage devices 31f to 31h are not used.

### (Application Example 3 of Operation of Switching Unit 40 in Discharge Mode)

Supply of the electric power stored in the electric power storage unit 30 to the load 100 may be performed in a state where all of the plurality of electric power storage devices 31 are connected in series (fourth discharge mode) via the switching unit 40.

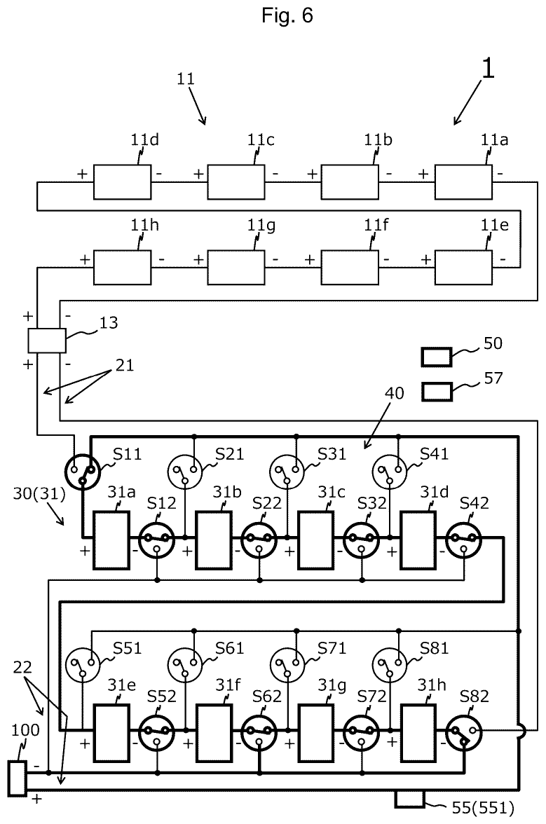

Specifically, the normally closed contacts and the fixed contacts of some switches of the switching unit 40 are connected, and the normally open contacts and the fixed contacts of the remaining switches of the switching unit 40 are connected (see FIG. 6).

FIG. 6 illustrates a state where the normally closed contacts and the fixed contacts of the 12-th switch S12, the 21-th switch S21, the 22-th switch S22, the 31-th switch S31, the 32-th switch S32, the 41-th switch S41, the 42-th switch S42, the 51-th switch S51, the 52-th switch S52, the 61-th switch S61, the 62-th switch S62, the 71-th switch S71, the 72-th switch S72, and the 81-th switch S81 are connected.

In this case, the electric power is supplied from the first to eighth electric power storage devices 31a to 31h to the load 100 in a state where the first to eighth electric power storage devices 31a to 31h are connected in series.

Therefore, in the present embodiment, the electric power stored in the electric power storage unit 30 is supplied to the load 100 in a state where a state where one of the plurality of electric power storage devices 31 is used, a state where at least some of the plurality of electric power storage devices 31 are connected in parallel, and a state where all of the plurality of electric power storage devices 31 are connected in series can be switched via the switching unit 40.

### (Operation Unit 50)

The operation unit 50 is a selection switch for the charge mode and the discharge mode.

In a case where a load test mode described below is executed, the operation unit 50 is also used for selection of the load test mode instead of or in addition to the discharge mode.

The operation unit 50 is also used for selection of the first to fourth discharge modes of the discharge mode.

The operation unit 50 is also used for selection of the electric power storage device 31 to be used in the third discharge mode.

However, the electric power supply system 1 may include a detection unit 55 that detects information regarding the electric power supplied from the electric power storage unit 30 to the load 100, and a control unit 57, and the control unit 57 may control the switching unit 40 based on the information obtained by the detection unit 55.

For example, the detection unit 55 includes a first current detection device 551 that detects a current value of a current flowing through the second electric power line 22 as the information regarding the electric power supplied from the electric power storage unit 30 to the load 100.

In a case where a resistance value of the load 100 is large and the current value obtained by the detection unit 55 (the first current detection device 551) is smaller than a current threshold, the control unit 57 controls each switch of the switching unit 40 so as to be in the second discharge mode or the fourth discharge mode.

In a case where the resistance value of the load 100 is small and the current value obtained by the detection unit 55 (the first current detection device 551) is larger than the current threshold, the control unit 57 controls each switch of the switching unit 40 so as to be in the first discharge mode or the third discharge mode.

### (Effects of Series Connection in Charge Mode and Parallel Connection in Discharge Mode)

In the present embodiment, the plurality of electric power storage devices 31 are connected in series in the charge mode.

As a result, a current flowing through the first electric power line 21 can be reduced, and a smaller-diameter cable can be used as the first electric power line 21 as compared with a form in which the plurality of electric power storage devices 31 are connected in parallel in the charge mode.

In the present embodiment, all of the plurality of electric power storage devices 31 are connected in parallel in the discharge mode, or one of the plurality of electric power storage devices 31 is used in the discharge mode.

As a result, it is possible to supply lower-voltage electric power to the load 100 as compared with a form in which the plurality of electric power storage devices 31 are connected in series in the discharge mode.

In the present embodiment, some of the plurality of electric power storage devices 31 are connected in series and some of the plurality of electric power storage devices are connected in parallel in the discharge mode.

As a result, it is possible to supply higher-voltage electric power to the load 100 as compared with a form in which all of the plurality of electric power storage devices 31 are connected in parallel in the discharge mode.

That is, it is possible to provide an electric power supply system and the like capable of efficiently supplying electric power to a load by using a plurality of electric power sources.

### (Effect of Setting Charging Switch to Normally Closed Contact)

In the present embodiment, a movable contact of each switch (such as the 11-th switch S11) of the switching unit 40 that is connected to the fixed contact in the charge mode is set to the normally closed contact.

Therefore, in a case where charge rates of the plurality of electric power storage devices 31 of the electric power storage unit 30 are low and each of the movable contacts cannot be driven, the charge mode is maintained, and the electric power obtained by the electric power generation unit 10 is supplied to the electric power storage unit 30.

### (Effect Obtained by Providing Detection Unit 55 and Control Unit 57)

It is possible to optimize the connection states of the plurality of electric power storage devices 31 when the electric power is supplied from the electric power storage unit 30 to the load 100 based on the information regarding the electric power supplied from the electric power storage unit 30 to the load 100.

### (Effect of Stacking Electric Power Storage Devices 31 in Vertical Direction via Insulator 33)

It is possible to dispose a large number of electric power storage devices 31 in a predetermined region while maintaining insulation properties.

### (Number of Solar Panels)

In the present embodiment, an example in which the electric power generation device 11 of the electric power generation unit 10 includes eight solar panels (the first to eighth solar panels 11a to 11h) has been described. However, the number of solar panels is not limited to eight.

### (Application Example of Electric Power Generation Device)

In the present embodiment, an example in which the electric power generation device 11 of the electric power generation unit 10 is a solar panel has been described.

However, the electric power generation device 11 may be another electric power generation device such as a fuel cell.

In a case where said another electric power generation device is an alternating current (AC) power generation device, an AC/DC converter is provided between the electric power generation device 11 and the electric power storage unit 30.

### (Number of Electric Power Storage Devices)

In the present embodiment, an example in which the electric power storage unit 30 includes eight electric power storage devices 31 (the first to eighth electric power storage devices 31a to 31h) has been described. However, the number of electric power storage devices 31 is not limited to eight.

(Application Example of Target to Which Electric Power is Supplied from Electric Power Storage Unit 30)

In the present embodiment, an example in which the electric power is supplied from the electric power storage unit 30 to the load 100 has been described.

The load 100 is an electric device that is driven by direct current.

However, the load 100 may be an electric device that is driven by alternating current.

In this case, a DC/AC inverter is provided between the load 100 and the electric power storage unit 30.

Furthermore, the load 100 may include a plurality of loads. Said plurality of loads may be connected in series or in parallel.

### (Application Example of Load Test Using Electric Power Storage Unit 30)

In the present embodiment, an example in which the electric power storage unit 30 receives the electric power supplied from the electric power generation unit 10 has been described (charge mode).

Further, in the present embodiment, an example in which the electric power storage unit 30 supplies the electric power to the load 100 has been described (discharge mode).

However, for a load test of a test target power source 200, the electric power storage unit 30 may receive electric power supplied from the test target power source 200 (load test mode).

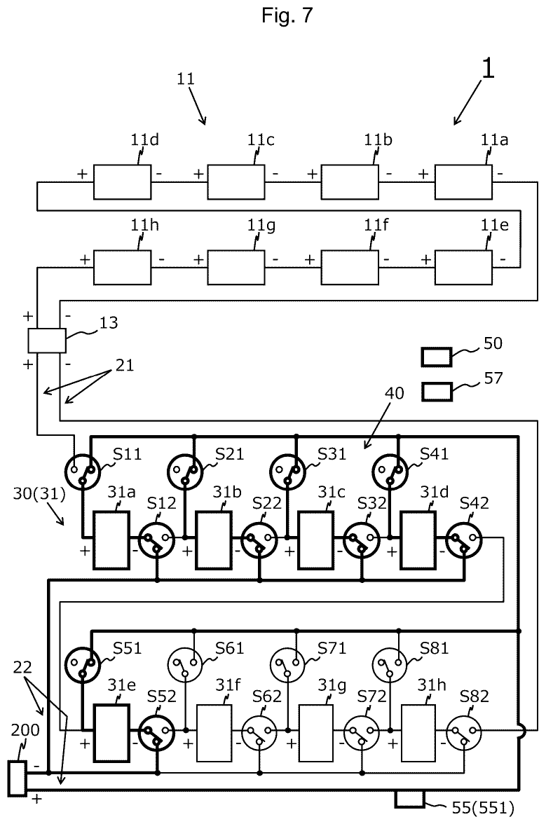

In the discharge mode, the electric power supply system 1 is connected to the load 100, but in the load test mode, the electric power supply system 1 is connected to the test target power source 200 (see FIG. 7).

In this case, the load 100 is replaced with the test target power source 200.

In the discharge mode, electric power supply from the electric power storage unit 30 to the load 100 is performed, but in the load test mode, electric power supply from the test target power source 200 to the electric power storage unit 30 is performed instead of the electric power supply from the electric power storage unit 30.

### (Operation 1 of Switching Unit 40 in Load Test Mode)

The electric power supply from the test target power source 200 to the electric power storage unit 30 is performed in a state where only one of the plurality of electric power storage devices 31 is used or in a state where two or more of the plurality of electric power storage devices 31 are connected in parallel via the switching unit 40.

Specifically, the normally open contact and the fixed contact of a switch corresponding to the electric power storage device 31 to be used among the switches of the switching unit 40 are connected.

The number of electric power storage devices to be used is increased or decreased according to a load amount.

Among the switches of the switching unit 40, the 11-th switch S11 and the 12-th switch S12 correspond to the first electric power storage device 31a.

Among the switches of the switching unit 40, the 21-th switch S21 and the 22-th switch S22 correspond to the second electric power storage device 31b.

Among the switches of the switching unit 40, the 31-th switch S31 and the 32-th switch S32 correspond to the third electric power storage device 31c.

Among the switches of the switching unit 40, the 41-th switch S41 and the 42-th switch S42 correspond to the fourth electric power storage device 31d.

Among the switches of the switching unit 40, the 51-th switch S51 and the 52-th switch S52 correspond to the fifth electric power storage device 31e.

Among the switches of the switching unit 40, the 61-th switch S61 and the 62-th switch S62 correspond to the sixth electric power storage device 31f.

Among the switches of the switching unit 40, the 71-th switch S71 and the 72-th switch S72 correspond to the seventh electric power storage device 31g.

Among the switches of the switching unit 40, the 81-th switch S81 and the 82-th switch S82 correspond to the eighth electric power storage device 31h.

FIG. 7 illustrates a state where the normally open contacts and the fixed contacts of the 11-th switch S11, the 12-th switch S12, the 21-th switch S21, the 22-th switch S22, the 31-th switch S31, the 32-th switch S32, the 41-th switch S41, the 42-th switch S42, the 51-th switch S51, the 52-th switch S52, the 62-th switch S62, the 72-th switch S72, and the 82-th switch S82 are connected, and the normally closed contacts and the fixed contacts of the 61-th switch S61, the 71-th switch S71, and the 81-th switch S81 are connected. The normally closed contacts and the fixed contacts of the 62-th switch S62, the 72-th switch S72, and the 82-th switch S82 may be connected.

In this case, the electric power is supplied from the test target power source 200 to the first to fifth electric power storage devices 31a to 31e in a state where the first to fifth electric power storage devices 31a to 31e are connected in parallel. The sixth to eighth electric power storage devices 31f to 31h are not used.

### (Application Example 1 of Operation of Switching Unit 40 in Load Test Mode)

The electric power supply from the test target power source 200 to the electric power storage unit 30 may be performed in a state where some of the plurality of electric power storage devices 31 are connected in series and some of the plurality of electric power storage devices 31 are connected in parallel via the switching unit 40.

### (Application Example 2 of Operation of Switching Unit 40 in Load Test Mode)

The electric power supply from the test target power source 200 to the electric power storage unit 30 may be performed in a state where all of the plurality of electric power storage devices 31 are connected in series via the switching unit 40.

Therefore, in the present embodiment, the electric power supply from the test target power source 200 to the electric power storage unit 30 is performed in a state where a state where one of the plurality of electric power storage devices 31 is used, a state where at least some of the plurality of electric power storage devices 31 are connected in parallel, and a state where the plurality of electric power storage devices 31 are connected in series can be switched via the switching unit 40.

### (Effect of Connecting Test Target Power Source 200 to Electric Power Supply System 1)

The load test of the test target power source 200 can be performed while switching the connection states of the plurality of electric power storage devices 31 by using the plurality of electric power storage devices 31, and the electric power storage device 31 can be charged.

### (Test Target Power Source 200)

The test target power source 200 is a device that generates direct current (DC) power, such as a generator. The test target power source 200 may be a device that generates alternating current (AC) power. In this case, a device (AC/DC converter) 60 that converts AC power into DC power is provided between the test target power source 200 and the electric power storage device 31.

Only one conversion device 60 may be provided. In this case, after the conversion device 60 converts AC power from the test target power source 200 into DC power, the DC power is supplied to the plurality of electric power storage devices 31.

The conversion device 60 may be provided for each electric power storage device 31. In this case, after AC power from the test target power source 200 is supplied to each conversion device 60 and converted into DC power, the DC power is supplied from each conversion device 60 to the plurality of electric power storage devices 31.

### (Application Example of Conversion Device 60)

The conversion device 60 is desirably a bidirectional AC/DC converter.

When the load 100 is connected to the electric power supply system 1, the bidirectional AC/DC converter converts a flow of electricity of the electric power from the electric power storage unit 30 to the load 100 from direct current to alternating current.

When the test target power source 200 is connected to the electric power supply system 1, the bidirectional AC/DC converter converts a flow of electricity of electric power from the test target power source 200 to the electric power storage unit 30 from alternating current to direct current.

### (Effect of Conversion Device 60 Including Bidirectional AC/DC Converter)

The load 100 driven by AC power and the test target power source 200 that generates AC power can be exchanged and used without changing an internal structure of the electric power supply system 1.

### (Application Example of AC Test Target Power Source 200)

The test target power source 200 may be a device that generates single-phase AC power or a device that generates three-phase AC power.

In a case where the test target power source 200 is a device that generates three-phase AC power, electric power is supplied to each electric power storage device 31 via the conversion device 60 using two of three electric power lines (U-phase line, V-phase line, and W-phase line) from the test target power source 200.

### (Application Example of Electric Power Storage Device 31)

In the present embodiment, an example in which electric power is supplied from the electric power generation unit 10 to all of the plurality of electric power storage devices 31 in the charge mode has been described.

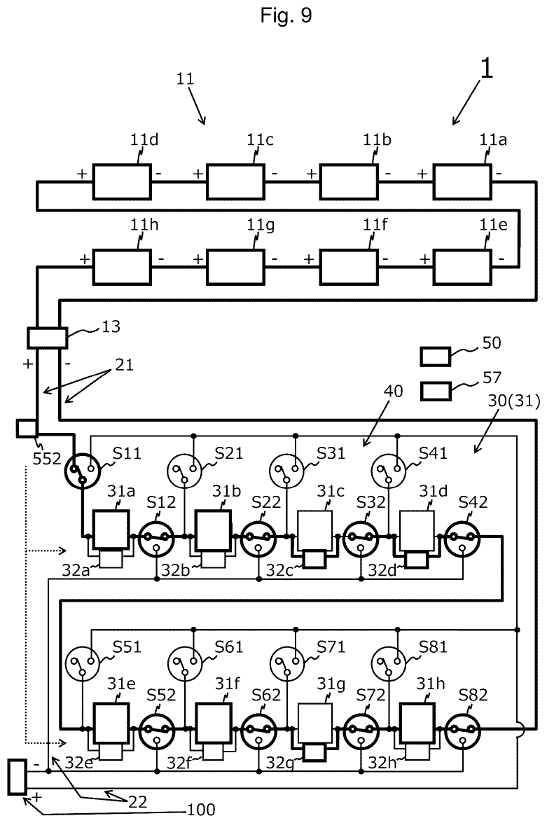

However, electric power supply to some of the plurality of electric power storage devices 31 may be suppressed based on a charge state (see FIG. 9).

In this case, the electric power storage unit 30 includes first to eighth charge control devices 32a to 32h.

### (First Charge Control Device 32a)

The first charge control device 32a is connected in parallel to the first electric power storage device 31a. The first charge control device 32a detects a charge rate (first charge rate R1) of the first electric power storage device 31a.

The first charge control device 32a includes a resistor, and in a case where the first charge rate R1 is equal to or higher than a first charge rate threshold Thr1, the first charge control device 32a suppresses electric power supply from the electric power generation unit 10 to the first electric power storage device 31a and supplies the electric power to said resistor.

Therefore, the electric power from the electric power generation unit 10 is supplied to the first electric power storage device 31a in a case where the first charge rate R1 is lower than the first charge rate threshold Thr1, and is supplied to the resistor of the first charge control device 32a in a case where the first charge rate R1 is equal to or higher than the first charge rate threshold Thr1.

The first charge control device 32a functions as a battery management system of the first electric power storage device 31a.

### (Second Charge Control Device 32b)

The second charge control device 32b is connected in parallel to the second electric power storage device 31b. The second charge control device 32b detects a charge rate (second charge rate R2) of the second electric power storage device 31b.

The second charge control device 32b includes a resistor, and in a case where the second charge rate R2 is equal to or higher than the first charge rate threshold Thr1, the second charge control device 32b suppresses electric power supply from the electric power generation unit 10 to the second electric power storage device 31b and supplies the electric power to said resistor.

Therefore, the electric power from the electric power generation unit 10 is supplied to the second electric power storage device 31b in a case where the second charge rate R2 is lower than the first charge rate threshold Thr1, and is supplied to the resistor of the second charge control device 32b in a case where the second charge rate R2 is equal to or higher than the first charge rate threshold Thr1.

The second charge control device 32b functions as a battery management system of the second electric power storage device 31b.

### (Third Charge Control Device 32c)

The third charge control device 32c is connected in parallel to the third electric power storage device 31c. The third charge control device 32c detects a charge rate (third charge rate R3) of the third electric power storage device 31c.

The third charge control device 32c includes a resistor, and in a case where the third charge rate R3 is equal to or higher than the first charge rate threshold Thr1, the third charge control device 32c suppresses electric power supply from the electric power generation unit 10 to the third electric power storage device 31c, and supplies the electric power to said resistor.

Therefore, the electric power from the electric power generation unit 10 is supplied to the third electric power storage device 31c in a case where the third charge rate R3 is lower than the first charge rate threshold Thr1, and is supplied to the resistor of the third charge control device 32c in a case where the third charge rate R3 is equal to or higher than the first charge rate threshold Thr1.

The third charge control device 32c functions as a battery management system of the third electric power storage device 31c.

### (Fourth Charge Control Device 32d)

The fourth charge control device 32d is connected in parallel to the fourth electric power storage device 31d. The fourth charge control device 32d detects a charge rate (fourth charge rate R4) of the fourth electric power storage device 31d.

The fourth charge control device 32d includes a resistor, and in a case where the fourth charge rate R4 is equal to or higher than the first charge rate threshold Thr1, the fourth charge control device 32d suppresses electric power supply from the electric power generation unit 10 to the fourth electric power storage device 31d, and supplies the electric power to said resistor.

Therefore, the electric power from the electric power generation unit 10 is supplied to the fourth electric power storage device 31d in a case where the fourth charge rate R4 is lower than the first charge rate threshold Thr1, and is supplied to the resistor of the fourth charge control device 32d in a case where the fourth charge rate R4 is equal to or higher than the first charge rate threshold Thr1.

The fourth charge control device 32d functions as a battery management system of the fourth electric power storage device 31d.

### (Fifth Charge Control Device 32e)

The fifth charge control device 32e is connected in parallel to the fifth electric power storage device 31e. The fifth charge control device 32e detects a charge rate (fifth charge rate R5) of the fifth electric power storage device 31e.

The fifth charge control device 32e includes a resistor, and in a case where the fifth charge rate R5 is equal to or higher than the first charge rate threshold Thr1, the fifth charge control device 32e suppresses electric power supply from the electric power generation unit 10 to the fifth electric power storage device 31e, and supplies the electric power to said resistor.

Therefore, the electric power from the electric power generation unit 10 is supplied to the fifth electric power storage device 31e in a case where the fifth charge rate R5 is lower than the first charge rate threshold Thr1, and is supplied to the resistor of the fifth charge control device 32e in a case where the fifth charge rate R5 is equal to or higher than the first charge rate threshold Thr1.

The fifth charge control device 32e functions as a battery management system of the fifth electric power storage device 31e.

### (Sixth Charge Control Device 32f)

The sixth charge control device 32f is connected in parallel to the sixth electric power storage device 31f.

The sixth charge control device 32f detects a charge rate (sixth charge rate R6) of the sixth electric power storage device 31f.

The sixth charge control device 32f includes a resistor, and in a case where the sixth charge rate R6 is equal to or higher than the first charge rate threshold Thr1, the sixth charge control device 32f suppresses electric power supply from the electric power generation unit 10 to the sixth electric power storage device 31f, and supplies the electric power to said resistor.

Therefore, the electric power from the electric power generation unit 10 is supplied to the sixth electric power storage device 31f in a case where the sixth charge rate R6 is lower than the first charge rate threshold Thr1, and is supplied to the resistor of the sixth charge control device 32f in a case where the sixth charge rate R6 is equal to or higher than the first charge rate threshold Thr1.

The sixth charge control device 32f functions as a battery management system of the sixth electric power storage device 31f.

### (Seventh Charge Control Device 32g)

The seventh charge control device 32g is connected in parallel to the seventh electric power storage device 31g.

The seventh charge control device 32g detects a charge rate (seventh charge rate R7) of the seventh electric power storage device 31g.

The seventh charge control device 32g includes a resistor, and in a case where the seventh charge rate R7 is equal to or higher than the first charge rate threshold Thr1, the seventh charge control device 32g suppresses electric power supply from the electric power generation unit 10 to the seventh electric power storage device 31g, and supplies the electric power to said resistor.

Therefore, the electric power from the electric power generation unit 10 is supplied to the seventh electric power storage device 31g in a case where the seventh charge rate R7 is lower than the first charge rate threshold Thr1, and is supplied to the resistor of the seventh charge control device 32g in a case where the seventh charge rate R7 is equal to or higher than the first charge rate threshold Thr1.

The seventh charge control device 32g functions as a battery management system of the seventh electric power storage device 31g.

### (Eighth Charge Control Device 32h)

The eighth charge control device 32h is connected in parallel to the eighth electric power storage device 31h.

The eighth charge control device 32h detects a charge rate (eighth charge rate R8) of the eighth electric power storage device 31h.

The eighth charge control device 32h includes a resistor, and in a case where the eighth charge rate R8 is equal to or higher than the first charge rate threshold Thr1, the eighth charge control device 32h suppresses electric power supply from the electric power generation unit 10 to the eighth electric power storage device 31h and supplies the electric power to said resistor.

Therefore, the electric power from the electric power generation unit 10 is supplied to the eighth electric power storage device 31h in a case where the eighth charge rate R8 is lower than the first charge rate threshold Thr1, and is supplied to the resistor of the eighth charge control device 32h in a case where the eighth charge rate R8 is equal to or higher than the first charge rate threshold Thr1.

The eighth charge control device 32h functions as a battery management system of the eighth electric power storage device 31h.

### (Effect of Providing First to Eighth Charge Control Devices 32a to 32h)

The electric power from the electric power generation unit 10 is supplied to the electric power storage device having a low charge rate, and is not supplied to the electric power storage device having a high charge rate. Therefore, it is possible to charge the electric power storage device having a low charge rate at an early stage while preventing deterioration of the electric power storage device having a high charge rate.

The resistors provided in the first to eighth charge control devices 32a to 32h may be omitted. However, in this case, a resistor is provided on a circuit including the first electric power line 21 in order to prevent a large current from flowing through the first electric power line 21 when the electric power from the electric power generation unit 10 is not supplied to all of the first to eighth electric power storage devices 31a to 31h and is supplied to all of the first to eighth charge control devices 32a to 32h.

Also in the discharge mode, the first charge rate R1 or the like may be utilized.

For example, in the third discharge mode, the control unit 57 can also control each switch of the switching unit 40 so that electric power is supplied to the load 100 by preferentially using one of the plurality of electric power storage devices 31 having a charge rate (the first to eighth charge rates R1 to R8) higher than the first charge rate threshold Thr1.

In a case where the first to eighth charge control devices 32a to 32h are provided, the detection unit 55 may further detect information regarding electric power supplied from the electric power generation unit 10 to the electric power storage unit 30.

For example, the detection unit 55 includes a second current detection device 552 that detects a current value of a current flowing through the first electric power line 21 as the information regarding the electric power supplied from the electric power generation unit 10 to the electric power storage unit 30.

In this case, the control unit 57 controls the first to eighth charge control devices 32a to 32h based on the information obtained by the second current detection device 552.

In a case where an electric power generation amount of the electric power generation device 11 is large and the current value obtained by the detection unit 55 (second current detection device 552) is smaller than the current threshold, the control unit 57 controls the first to eighth charge control devices 32a to 32h in such a way that electric power supply to a large number of electric power storage devices 31 is suppressed, that is, electric power is supplied only to an electric power storage device whose charge rate R is lower than a second charge rate threshold Thr2. The second charge rate threshold Thr2 is smaller than the first charge rate threshold Thr1 (Thr1>Thr2).

In a case where the electric power generation amount of the electric power generation device 11 is small and the current value obtained by the detection unit 55 (second current detection device 552) is larger than the current threshold, the control unit 57 controls the first to eighth charge control devices 32a to 32h in such a way that electric power supply to a large number of electric power storage devices 31 is performed, that is, electric power is supplied to an electric power storage device whose charge rate R is lower than the first charge rate threshold Thr1.

That is, in a case where the first charge rate R1 is equal to or higher than the first charge rate threshold Thr1, the first charge control device 32a suppresses electric power supply from the electric power generation unit 10 to the first electric power storage device 31a regardless of the information obtained by the detection unit 55 (second current detection device 552). In a case where the first charge rate R1 is lower than the first charge rate threshold Thr1 and is equal to or higher than the second charge rate threshold Thr2, the first charge control device 32a suppresses electric power supply from the electric power generation unit 10 to the first electric power storage device 31a based on the information obtained by the detection unit 55 (second current detection device 552).

Similarly, in a case where the second charge rate R2 is equal to or higher than the first charge rate threshold Thr1, the second charge control device 32b suppresses electric power supply from the electric power generation unit 10 to the second electric power storage device 31b regardless of the information obtained by the detection unit 55 (second current detection device 552). In a case where the second charge rate R2 is lower than the first charge rate threshold Thr1 and is equal to or higher than the second charge rate threshold Thr2, the second charge control device 32b suppresses electric power supply from the electric power generation unit 10 to the second electric power storage device 31b based on the information obtained by the detection unit 55 (second current detection device 552).

Similarly, in a case where the third charge rate R3 is equal to or higher than the first charge rate threshold Thr1, the third charge control device 32c suppresses electric power supply from the electric power generation unit 10 to the third electric power storage device 31c regardless of the information obtained by the detection unit 55 (second current detection device 552). In a case where the third charge rate R3 is lower than the first charge rate threshold Thr1 and is equal to or higher than the second charge rate threshold Thr2, the third charge control device 32c suppresses electric power supply from the electric power generation unit 10 to the third electric power storage device 31c based on the information obtained by the detection unit 55 (second current detection device 552).

Similarly, in a case where the fourth charge rate R4 is equal to or higher than the first charge rate threshold Thr1, the fourth charge control device 32d suppresses electric power supply from the electric power generation unit 10 to the fourth electric power storage device 31d regardless of the information obtained by the detection unit 55 (second current detection device 552). In a case where the fourth charge rate R4 is lower than the first charge rate threshold Thr1 and is equal to or higher than the second charge rate threshold Thr2, the fourth charge control device 32d suppresses electric power supply from the electric power generation unit 10 to the fourth electric power storage device 31d based on the information obtained by the detection unit 55 (second current detection device 552).

Similarly, in a case where the fifth charge rate R5 is equal to or higher than the first charge rate threshold Thr1, the fifth charge control device 32e suppresses electric power supply from the electric power generation unit 10 to the fifth electric power storage device 31e regardless of the information obtained by the detection unit 55 (second current detection device 552). In a case where the fifth charge rate R5 is lower than the first charge rate threshold Thr1 and is equal to or higher than the second charge rate threshold Thr2, the fifth charge control device 32e suppresses electric power supply from the electric power generation unit 10 to the fifth electric power storage device 31e based on the information obtained by the detection unit 55 (second current detection device 552).

Similarly, in a case where the sixth charge rate R6 is equal to or higher than the first charge rate threshold Thr1, the sixth charge control device 32f suppresses electric power supply from the electric power generation unit 10 to the sixth electric power storage device 31f regardless of the information obtained by the detection unit 55 (second current detection device 552). In a case where the sixth charge rate R6 is lower than the first charge rate threshold Thr1 and is equal to or higher than the second charge rate threshold Thr2, the sixth charge control device 32f suppresses electric power supply from the electric power generation unit 10 to the sixth electric power storage device 31f based on the information obtained by the detection unit 55 (second current detection device 552).

Similarly, in a case where the seventh charge rate R7 is equal to or higher than the first charge rate threshold Thr1, the seventh charge control device 32g suppresses electric power supply from the electric power generation unit 10 to the seventh electric power storage device 31g regardless of the information obtained by the detection unit 55 (second current detection device 552). In a case where the seventh charge rate R7 is lower than the first charge rate threshold Thr1 and is equal to or higher than the second charge rate threshold Thr2, the seventh charge control device 32g suppresses electric power supply from the electric power generation unit 10 to the seventh electric power storage device 31g based on the information obtained by the detection unit 55 (second current detection device 552).

Similarly, in a case where the eighth charge rate R8 is equal to or higher than the first charge rate threshold Thr1, the eighth charge control device 32h suppresses electric power supply from the electric power generation unit 10 to the eighth electric power storage device 31h regardless of the information obtained by the detection unit 55 (second current detection device 552). In a case where the eighth charge rate R8 is lower than the first charge rate threshold Thr1 and is equal to or higher than the second charge rate threshold Thr2, the eighth charge control device 32h suppresses electric power supply from the electric power generation unit 10 to the eighth electric power storage device 31h based on the information obtained by the detection unit 55 (second current detection device 552).

### (Effects of Providing First to Eighth Charge Control Devices 32a to 32h and Second Current Detection Device 552)

The electric power from the electric power generation unit 10 is supplied to the electric power storage device having a low charge rate, and is not supplied to the electric power storage device having a high charge rate. The presence or absence of electric power supply from the electric power generation unit 10 to the electric power storage device having a medium charge rate is controlled based on the information regarding electric power supplied from the electric power generation unit 10 to the electric power storage unit 30. Therefore, it is possible to charge the electric power storage device having a low charge rate at an early stage according to an electric power supply situation.

FIG. 9 illustrates a state where electric power supply to the first electric power storage device 31a, the second electric power storage device 31b, the fifth electric power storage device 31e, the sixth electric power storage device 31f, and the eighth electric power storage device 31h is performed, and electric power supply to the third electric power storage device 31c, the fourth electric power storage device 31d, and the seventh electric power storage device 31g is suppressed.

### (Application Example of First to Eighth Charge Control Device 32a to 32h)

An example in which the first to eighth charge control devices 32a to 32h, based on the charge rate R of the corresponding electric power storage device 31, suppress electric power supply to said electric power storage device 31 has been described above.

However, in addition to the charge rate R, the first to eighth charge control devices 32a to 32h may suppress electric power supply to a corresponding electric power storage device 31 based on a manual operation using the operation unit 50.

Specifically, electric power from the electric power generation unit 10 is supplied to one or more of the first to eighth electric power storage devices 31a to 31h whose charge rate R is lower than the first charge rate threshold Thr1, for the load test of the electric power generation unit 10 according to the load amount set via the operation unit 50. Electric power supply from the electric power generation unit 10 to the other electric power storage devices 31 is suppressed by any one (corresponding charge control device) of the first to eighth charge control devices 32a to 32h.

In a case where suppression of charge of a large number of electric power storage devices 31 is selected by a manual operation using the operation unit 50, the control unit 57 controls the first to eighth charge control devices 32a to 32h in such a way that electric power supply to a large number of electric power storage devices 31 is suppressed, that is, electric power is supplied only to an electric power storage device whose charge rate R is lower than the second charge rate threshold Thr2.

In a case where charge of a large number of electric power storage devices 31 is selected by a manual operation using the operation unit 50, the control unit 57 controls the first to eighth charge control devices 32a to 32h in such a way that electric power is supplied to a large number of electric power storage devices 31, that is, electric power is supplied to an electric power storage device whose charge rate R is lower than the first charge rate threshold Thr1.

### (Application Example of Load Test Mode)

In this case, the load test of the electric power generation unit 10 can also be performed by selecting the number of electric power storage device 31 to be charged by a manual operation using the operation unit 50.

Although some embodiments of the present invention have been described, these embodiments have been presented as examples, and are not intended to limit the scope of the invention. These embodiments can be implemented in various other forms, and various omissions, substitutions, and changes can be made without departing from the gist of the invention. The accompanying claims and their equivalents are intended to cover these embodiments and modifications thereof as would fall within the scope and gist of the invention.

### REFERENCE SIGNS LIST

1 Electric power supply system

10 Electric power generation unit

11 Electric power generation device

11a to 11h First to eight solar panels

13 Charge/discharge controller

20 Electric power supply unit

21 First electric power line

22 Second electric power line

30 Electric power storage unit

31 Electric power storage device

31a to 31h First to eighth electric power storage devices

32a to 32h First to eighth charge control devices

33 Insulator

40 Switching unit

50 Operation unit

55 Detection unit

551 First current detection device

552 Second current detection device

57 Control unit

60 Conversion device

100 Load

200 Test target power source

R1 to R8 First to eighth charge rates

S11 11-th switch

S12 12-th switch

S21 21-th switch

S22 22-th switch

S31 31-th switch

S32 32-th switch

S41 41-th switch

S42 42-th switch

S51 51-th switch

S52 52-th switch

S61 61-th switch

S62 62-th switch

S71 71-th switch

S72 72-th switch

S81 81-th switch

S82 82-th switch

Thr1 First charge rate threshold

Thr2 Second charge rate threshold

1. An electric power supply system that supplies electric power to an external load, the electric power supply system comprising:
an electric power generation unit configured to generate the electric power;
an electric power storage unit including a plurality of electric power storage devices; and
a switching unit configured to switch connection states of the plurality of electric power storage devices, wherein
the electric power obtained by the electric power generation unit is supplied to the electric power storage unit in a state where the plurality of electric power storage devices are connected in series, via the switching unit, and
the electric power stored in the electric power storage unit is supplied to the load in a state where at least a state where one of the plurality of electric power storage devices is used and a state where at least some of the plurality of electric power storage devices are connected in parallel are switchable via the switching unit.

2. The electric power supply system according to claim 1, wherein
the plurality of electric power storage devices include a first electric power storage device and a second electric power storage device,
the electric power storage unit includes a first charge control device connected in parallel to the first electric power storage device, and a second charge control device connected in parallel to the second electric power storage device, and
the first charge control device detects a first charge rate of the first electric power storage device,
the second charge control device detects a second charge rate of the second electric power storage device,
the first charge control device suppresses electric power supply from the electric power generation unit to the first electric power storage device in a case where the first charge rate is equal to or higher than a first charge rate threshold, and
the second charge control device suppresses electric power supply from the electric power generation unit to the second electric power storage device in a case where the second charge rate is equal to or higher than the first charge rate threshold.

3. The electric power supply system according to claim 2, further comprising a detection unit configured to detect information regarding the electric power supplied from the electric power generation unit to the electric power storage unit, wherein
the first charge control device suppresses electric power supply from the electric power generation unit to the first electric power storage device based on the information obtained by the detection unit in a case where the first charge rate is lower than the first charge rate threshold and is equal to or higher than a second charge rate threshold lower than the first charge rate threshold, and
the second charge control device suppresses electric power supply from the electric power generation unit to the second electric power storage device based on the information obtained by the detection unit in a case where the second charge rate is lower than the first charge rate threshold and is equal to or higher than the second charge rate threshold.

4. The electric power supply system according to claim 2, further comprising an operation unit, wherein
the plurality of electric power storage devices include a third electric power storage device,
the electric power storage unit includes a third charge control device connected in parallel to the third electric power storage device,
the third charge control device detects a third charge rate of the third electric power storage device,
the third charge control device suppresses electric power supply from the electric power generation unit to the third electric power storage device in a case where the third charge rate is equal to or higher than the first charge rate threshold, and
the electric power from the electric power generation unit is supplied to one or more of the first to third electric power storage devices whose charge rate is lower than the first charge rate threshold, for a load test of the electric power generation unit according to a load amount set via the operation unit, and electric power supply from the electric power generation unit to other electric power storage devices is suppressed by any of the first to third charge control devices.

5. The electric power supply system according to claim 1, wherein
the switching unit includes a plurality of switches,
a normally closed contact and a fixed contact of each of the plurality of switches are connected when the electric power obtained by the electric power generation unit is supplied to the electric power storage unit, and
a normally open contact and the fixed contact of at least one of the plurality of switches are connected when the electric power stored in the electric power storage unit is supplied to the load.

6. The electric power supply system according to claim 5, further comprising:
a detection unit configured to detect at least one of information regarding the electric power supplied from the electric power storage unit to the load or information regarding charge states of the plurality of electric power storage devices; and
a control unit configured to control the switching unit when supplying the electric power from the electric power storage unit to the load based on the information obtained by the detection unit.

7. The electric power supply system according to claim 1, wherein
the electric power supply system receives electric power supply from an external test target power source,
the electric power storage unit is used for a load test of the test target power source, and
electric power supply from the test target power source to the electric power storage unit is performed in a state where a state where one of the plurality of electric power storage devices is used, a state where at least some of the plurality of electric power storage devices are connected in parallel, and a state where the plurality of electric power storage devices are connected in series are switchable via the switching unit.

8. The electric power supply system according to claim 7, further comprising a bidirectional AC/DC converter, wherein
in a case where the load is driven by AC power and receives the electric power supplied from the electric power storage unit, the bidirectional AC/DC converter converts a flow of electricity of the electric power from the electric power storage unit from DC to AC, and
in a case where the test target power source is a device that generates AC power and supplies the electric power to the electric power storage unit, the bidirectional AC/DC converter converts a flow of electricity of the electric power from the test target power source from AC to DC.

9. The electric power supply system according to claim 1, wherein at least two of the plurality of electric power storage devices are stacked via an insulator.

10. The electric power supply system according to claim 8, wherein the plurality of electric power storage devices are removably held.

11. The electric power supply system according to claim 1, wherein
the electric power generation unit includes a plurality of solar panels, and
the plurality of solar panels are connected in series.
